(19) United States
(12) Patent Application Publication
(10) Pub. No.: US 2007/0255836 A1
(43) Pub. Date: Nov. 1, 2007

(54) Agent allocation program, method and apparatus

(75) Inventors: Toshihiro Takahashi, Kanagawa-ken (JP); Hideyuki Mizuta, Kanagawa-ken (JP)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: International Business Machines Corporation, Armonk, NY (US)

(21) Appl. No.: 11/686,370

(22) Filed: Mar. 15, 2007

(30) Foreign Application Priority Data
Apr. 27, 2006 (JP) 2006-123367

(51) Int. Cl. G06F 15/173

(52) U.S. Cl. 709/226

(57) ABSTRACT

There is provided a program for allocating an agent on a computer including a plurality of interconnected nodes, each having a CPU and a memory; the program causing each of the nodes of the computer to perform the steps of: storing the amount of data transmitted between an agent residing on the node and a node with which the agent has communicated; determining for each agent a node M that results in the largest reduction in the amount of data transmitted when the agent is transferred to the node M; adding the agent to an agent list containing candidate agents to be transferred to the node M; and transferring agents on the agent list to the node M.

### BACKGROUND OF THE INVENTION

The present invention relates to a method for allocating agents in a multinode environment and, in particular, to an agent allocating method that reduces the network load among nodes.

Today, a large number of agents are run on a computer including nodes, each having a CPU and a memory, interconnected through a fast network (multinode computer) to perform simulations of complicated physical and economical phenomena. An agent is a part (object component) of a program representing an individual acting entity or economic entity that acts autonomously.

To perform a simulation on a multinode computer, agents must be allocated to multiple nodes. When an agent that belongs to a node sends and receives messages to and from an agent on another node, traffic occurs between the nodes. Since the amount of data transmitted between nodes affects the overall system performance, there has been a need for a method for reducing the traffic.

Conventional-art methods are known such as a method for reducing the lengths of communication paths to reduce the amount of data flowing through a network and a method for allocating applications executed in a distributed environment among nodes to balance CPU and network loads across the nodes. However, none of these approaches provide a method for allocating a large number of agents quickly and appropriately with a small amount of computation in an situation in which agents frequently communicates with each other, for example in an environment in which several million agents are used to perform a simulation.

### SUMMARY OF THE INVENTION

The present invention has been made in order to solve the technical problem and objects of the present invention are to:
allocate agents on a computer quickly and appropriately,
reduce the traffic between nodes,
reduce the network load between nodes, and
allocate agents that frequently communicate with each other to the same node.

To achieve these object, the present invention provides a program for allocating an agent on a computer including a plurality of interconnected nodes, each having a CPU and a memory; the program causing each of the nodes of the computer to perform the steps of: storing the amount of data transmitted between an agent residing on the node and a node with which the agent has communicated; determining for each agent a node M that results in the largest reduction in the amount of data transmitted when the agent is transferred to the node M; adding the agent to an agent list containing candidate agents to be transferred to the node M; and transferring agents on the agent list to the node M.

The step of storing the amount of data transmitted of communication with a node may calculate and store the amount of data transmitted between an agent residing on the node and a node from the amount of data transmitted between the agent and another agent with which the agent has communicated.

The step of determining a node M may determine for each agent the node M that results in the largest amount of reduction in traffic when the agent is transferred from the current node to another node, the amount of reduction being the amount of data transmitted at the node to which the agent is to be transferred minus the amount of data transmitted at the current node.

The step of transferring may sort the agents on the agent list in descending order of the amount of reduction in traffic and transfer a predetermined number of higher-order agents on the agent list from the current node to the node M.

According to the present invention, agents are appropriately allocated on a multinode computer to reduce the network load among nodes. Because traffic between nodes is reduced constantly, situations in which traffic between agents changes over time can be flexibly addressed.

### BRIEF DESCRIPTION OF THE SEVERAL VIEWS OF THE DRAWINGS

FIG. 1 shows an exemplary practical configuration of multiple nodes;

FIG. 2 shows an exemplary hardware configuration of a node;

FIG. 3 shows an exemplary configuration of a network of nodes on a three-dimensional torus;

FIG. 4 is an example of communications among four nodes;

FIG. 5 is a flowchart of an agent management program; and

FIG. 6 is a diagram illustrating agents in a virtual environment.

### DETAILED DESCRIPTION OF THE INVENTION

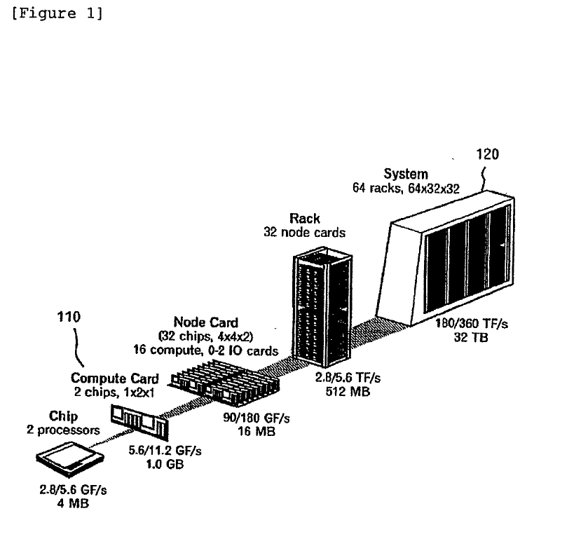

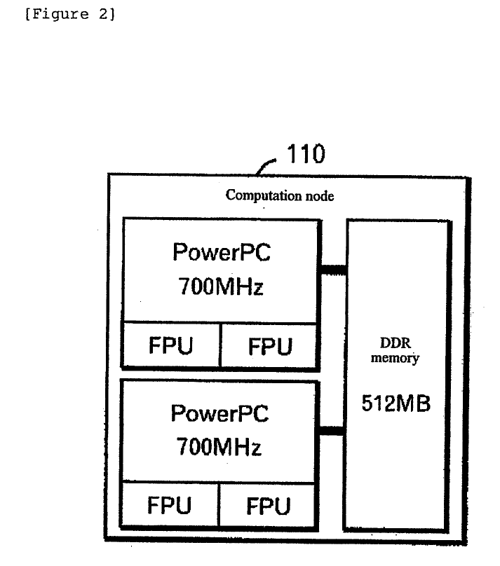

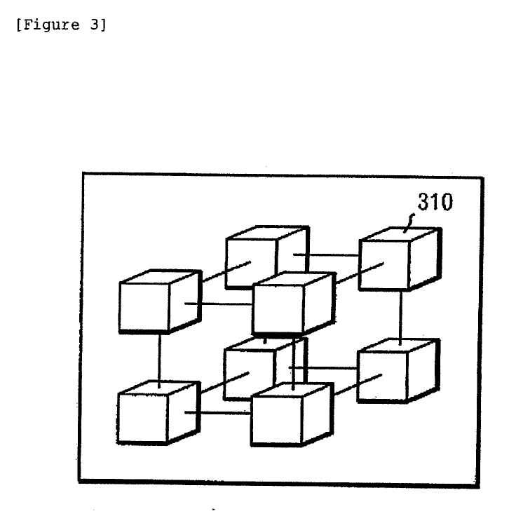

A preferred embodiment for implementing the present invention will be described in detail with reference to the accompanying drawings. A node of the present invention typically includes two chips and one memory as illustrated at 110 in FIG. 2. One chip includes one central processing unit and two floating-point units. The memory is connected to two chips. The two chips act as follows. One of chips is responsible for performing computation and the other performs communications in some cases and both perform computations in other cases. An exemplary practical configuration of multiple nodes is shown in FIG. 1. A Compute Card in FIG. 1 represents a node in the present invention. Sixteen Compute Cards make up a Node Card, 32 Node Cards make up a Rack, and 64 Racks make up a multinode computer 120. These nodes are interconnected through a fast network to form a network on a three-dimensional torus as illustrated in FIG. 3. A node 310 corresponds to a Compute Card in FIG. 1. Information about distances between nodes on the three-dimensional torus is not used in the present invention.

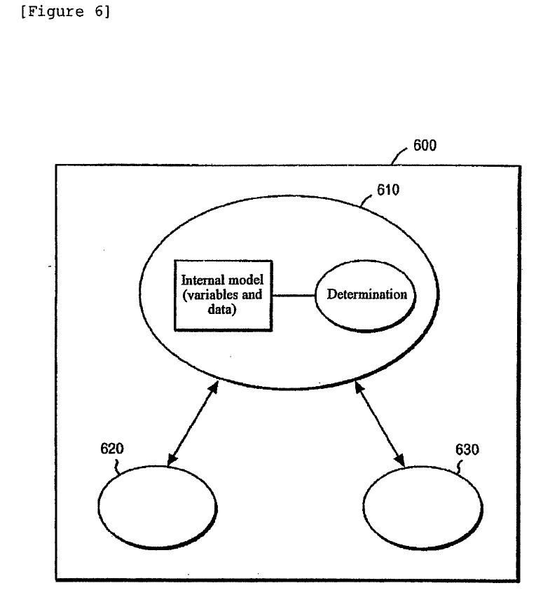

An agent is an object component running on the node and can transfer from the node to another node. FIG. 6 shows an overview of a simulation that uses multiple agents. A virtual environment 600 is built on a multinode computer 12. Multiple nodes and a large number of agents together perform a simulation of a complicated physical or economic phenomenon. An agent 610 includes an internal model that represents variables and data and a section (function) that determines the internal model. The agent acts in accordance with the result of the determination. The acts include computation, storage, message transmission and reception. Messages are sent to and received from other agents 620, 630.

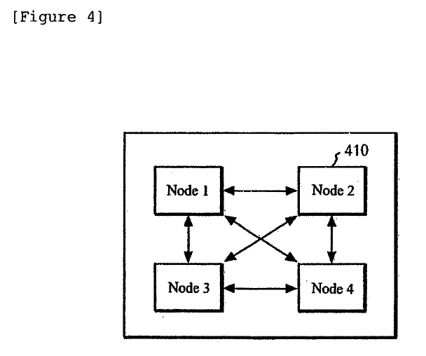

In a method according to the present invention, each agent records which agent (node) the agent communicated with and how much. Based on the information, a predetermined number of agents are exchanged among all nodes. FIG. 4 shows an example of communications among four nodes. A node 410 communicates with the other nodes. Communications between nodes include communications between an agent and a node. Huge volumes of traffic will be generated between several million agents and nodes. Reduction of the traffic between agents and nodes leads directly to reduction in traffic among the nodes.

A program that manages transfer of such a large amount of agents runs on each node and transfers appropriate agents to another node. The management program uses a smaller amount of resources than that used by the large number of agents, is simple, and operates fast, and therefore its impact on the overall system performance is small. Processes of the management program may be implemented by dedicated hardware.

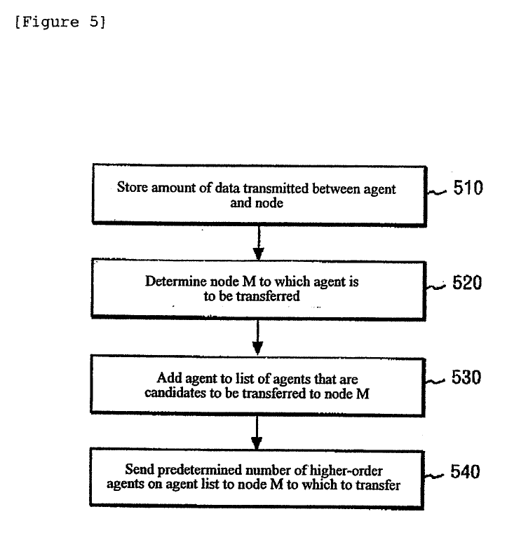

FIG. 5 shows a flowchart of the agent management program. At step 510, the volumes of traffic between each agent and nodes are stored. At step 520, a node M to which the agent is to be transferred is determined. Then, at step 530, the agent is added to a list of candidate agents to be transferred to the node M. Finally, at step 540, a predetermined number of higher-order agents on the agent list are sent to the node M. The process is performed on each node. It should be noted that the node M to which agents are transferred is not a particular node; agents can be transferred to any of the nodes.

The flow of the process will be described in detail. A set of agents is denoted by A, a set of nodes is denoted by C, a set of agents that belong to node k∈C is denoted by Bₖ⊂A, and the amount of data transmitted between agents i and i′∈A is denoted by T(i, i′).

At step 510, the amount of data transmitted S between each agent on a given node k and an agent that belongs to each node is obtained and stored on the node k.

$$S ( i , {B}_{{k}^{′}} ) = {\sum }_{{i}^{′} ∈ {B}_{{k}^{′}}} T ( i , {i}^{′} ) \qquad [ Formula 1 ]$$

At step 520, the amount of data transmitted that will be reduced if the agent i is transferred to node k′∈C is obtained as follows.

ΔR(i,Bₖ,Bₖ′)=S(i,bₖ)−S(i,b_{k′})

Node kₘₐₓ that maximize ΔR(i, B_{k′}, Bₖ) is obtained.

$${k}_{max} = {arg max}_{{k}^{′}} Δ R ( i , {B}_{k} , {B}_{{k}^{′}} ) \qquad [ Formula 2 ]$$

At step 530, the agent i is added to a set of candidate agents to be transferred to node kₘₐₓ:

Bpool_{k→k}_{ₘₐₓ}⊂A [Formula 3]

At step 540, a set of predetermined number of agents, Bₖ→_{k′}, is selected from Bpoolₖ→_{k′} for each node k′∈C in descending order of value ΔR(i, Bₖ, B_{k′}) and sent to node k′ (corresponding to node M in the flowchart).

By performing the process on every node at regular time intervals, agents can be reallocated to appropriate nodes. As can be seen from the flowchart described above, each node stores only the volumes of traffic generated by agents that belong to the node and checks only the agents that belongs to the node to select agents to exchange. Therefore, the method according to the present invention does not require complicated negotiations between nodes and operates fast with a remarkably small amount of computation.

That which is claimed is:

1) A program for allocating an agent on a computer including a plurality of interconnected nodes, each having a CPU and a memory; the program causing each of the nodes of the computer to perform the steps of:
storing an amount of data transmitted between an agent residing on the node and a node with which the agent has communicated;
determining for each agent a node M that results in the largest reduction in the amount of data transmitted when the agent is transferred to the node M;
adding the agent to an agent list containing candidate agents to be transferred to the node M; and
transferring agents on the agent list to the node M.

2) The program according to claim 1, wherein the step of storing the amount of data transmitted of communication with a node calculates and stores the amount of data transmitted between an agent residing on the node and a node from the amount of data transmitted between the agent and another agent with which the agent has communicated.

3) The program according to claim 1, wherein the step of determining a node M determines for each agent the node M that results in the largest amount of reduction in traffic when the agent is transferred from the current node to another node, the amount of reduction being the amount of data transmitted at the node to which the agent is to be transferred minus the amount of data transmitted at the current node.

4) The program according to claim 1, wherein the step of transferring sorts the agents on the agent list in descending order of the amount of reduction in traffic and transfers a predetermined number of higher-order agents on the agent list from the current node to the node M.

5) A method for allocating an agent on a computer including a plurality of interconnected nodes, each having a CPU and a memory, the method comprising:
in each of the nodes,
storing the amount of data transmitted between an agent residing on the node and a node with which the agent has communicated;
determining for each agent a node M that results in the largest reduction in the amount of data transmitted when the agent is transferred to the node M;
adding the agent to an agent list containing candidate agents to be transferred to the node M; and
transferring agents on the agent list to the node M.

6) An apparatus which allocates an agent on a computer including a plurality of interconnected nodes, each having a CPU and a memory, the apparatus comprising:
in each of the nodes,
means for storing the amount of data transmitted between an agent residing on the node and a node with which the agent has communicated;
means for determining for each agent a node M that results in the largest reduction in the amount of data transmitted when the agent is transferred to the node M;
means for adding the agent to an agent list containing candidate agents to be transferred to the node M; and
means for transferring agents on the agent list to the node M.
